(19) United States
(12) Patent Application Publication
(10) Pub. No.: US 2026/0212782 A1
(43) Pub. Date: Jul. 23, 2026

(54) SIMULATOR FOR PHYSICALLY SIMULATING ELECTRICAL FAULTS IN AN ELECTRIC VEHICLE AND METHOD OF TRAINING THEREWITH

(71) Applicant: Inter-Industry Conference on Auto Collision Repair, Hoffman Estates, IL (US)

(72) Inventors: Jeffrey Scott Poole, Appleton, WI (US); Joel Dufkis, Mount Prospect, IL (US)

(73) Assignee: Inter-Industry Conference on Auto Collision Repair, Hoffman Estates, IL (US)

(21) Appl. No.: 19/454,700

(22) Filed: Jan. 21, 2026

Related U.S. Application Data
(60) Provisional application No. 63/747,475, filed on Jan. 21, 2025.

(51) Int. Cl. G09B 23/18

(52) U.S. Cl. CPC G09B 23/188

(57) ABSTRACT

A simulator for physically simulating electrical faults in an electric vehicle may have an electric motor electronics unit, a first battery for simulating a high voltage battery and a plurality of electrical switches for simulating ground faults within the simulator. The simulator is useful to train a person to repair an electric vehicle or a hybrid vehicle having a high voltage battery.

This application claims priority to U.S. Provisional Application No. 63/747,475 filed Jan. 1, 2025. The entire disclosure of the provisional application is incorporated herein by reference.

### FIELD OF THE INVENTION

The invention is in the field of physical simulators for training technicians in the maintenance and repair of electric vehicles including and in the field of training technicians to maintain and repair electric vehicles.

### BACKGROUND

Electric vehicles (“EVs”) and hybrid vehicles (“hybrids”) are becoming increasingly popular. While there are many similarities between such vehicles and conventional vehicles with internal combustion engines (“conventional vehicles”), there are also many differences especially as to powertrain systems. Accordingly, there is a growing need to train technicians to service these vehicles, especially their powertrain systems.

Like conventional vehicles, EVs and hybrids have an electrical system for operating the vehicle which can include a radio, turn signals, and certain electronics. This electrical system operates at 12V DC nominally and includes a 12V battery. Unlike conventional vehicles, the EVs have an electrical system for propulsion or locomotion including a battery having an operating voltage of 400-900 V typically while the electrical motors which turn the wheels of a car operate at even higher voltages. Even components like air conditioning compressors and heaters are different for EVs. In a conventional vehicle, the air conditioning compressor runs off of the engine and heat is provided by the engine. In contrast, an EV needs a dedicated heater as there is no engine producing waste heat and the heater and air conditioning compressor are electrically operated often around 250 VDC. Hybrids are more similar to EVs than conventional vehicles although the voltages for the powertrain system tends to be lower. Accordingly, there is a need to train mechanics and technicians to repair and maintain EVs and hybrids.

The higher voltages in an EV are dangerous and could potentially injure or kill someone servicing the EV. Hands-on training for someone to service an EV or hybrid therefore involves an electrocution risk of death for the trainee and as a result the trainee's learning may be impeded by the fear of electrocution. Accordingly, a way to train trainees to service EVs and hybrids while eliminating the electrocution risk is needed. Simulators have been created but they were clunky, and it was difficult to conceal changes to the simulator.

There are virtual simulators, which do not pose an electrocution risk of death, but many people learn better in a real-world hands-on environment.

### SUMMARY OF THE INVENTION

One embodiment of the invention is a low-voltage simulator for physically simulating electrical faults in an electric vehicle or a hybrid vehicle having a high voltage electrical motor for training automotive technicians to physically locate electrical faults in the electric vehicle. The simulator has an electric motor electronics unit having an inverter, a DC/DC converter and an on board charger. The simulator has a first battery for simulating a high voltage battery. The first battery is connected to the electric motor electronics unit. The simulator has a plurality of electrical switches for simulating ground faults within the simulator. Each of these switches are connected to a ground and to a different electrical component of the simulator. The electrical components include the electric motor electronics unit and the first battery.

Optionally, the simulator includes a stator of an electric motor connected to the electric motor electronics unit. The stator is an electrical component of the simulator. The plurality of electrical switches includes a switch for simulating a ground fault at the stator. Additionally, the simulator includes at least one environmental control unit, i.e., an air conditioning compressor or a heater. The at least one environmental control unit is connected to the electric motor electronics unit and is an electrical component of the simulator. The plurality of electrical switches includes at least one switch for simulating a ground fault at the least one environmental control unit.

Optionally, the simulator has an opaque enclosure around the plurality of electrical switches. The enclosure may have an opaque locking door for providing access to the switches and hiding the switches when the door is closed.

Optionally, the simulator includes a varistor. The plurality of electrical switches are grounded through the varistor.

Optionally, the simulator includes a metallic wheeled cart for supporting the simulator. The plurality of switches are grounded to the wheeled cart.

Optionally, the simulator includes an electrical loop for simulating a high voltage interlock loop in the electric vehicle or the hybrid vehicle, a key sensor for simulating an ignition switch of the electric vehicle or the hybrid vehicle, and one or more indicators for indicating a status of the key switch and a status of the electrical loop.

Another embodiment of the invention is a method of training a person to repair an electric vehicle or a hybrid vehicle having a high voltage battery for storing energy to propel the vehicle. The method uses a low-voltage simulator for physically simulating electrical faults in the vehicle. The simulator includes (a) an electric motor electronics unit having an inverter, a DC/DC converter and an on board charger, (b) a first battery for simulating a high voltage battery, and (c) a plurality of electrical switches for simulating ground faults within the simulator. The first battery is connected to the electric motor electronics unit. Each of the plurality of electrical switches is connected to a ground and to a different electrical component of the simulator. The electrical components include the electric motor electronics unit and the first battery. The method includes simulating one or more grounding faults in the simulator by closing one or more of the switches.

Optionally, the method includes allowing the person to identify which component of the simulator has been grounded. The method includes instructing the person to break an electrical loop for simulating a high voltage interlock loop in the electric vehicle or the hybrid vehicle and to check the one or more indicators before allowing the person to identify which component of the simulator has been grounded. The simulator has a key sensor for simulating an ignition switch of the electric vehicle or the hybrid vehicle, and one or more indicators for indicating a status of the key switch and a status of the electrical loop.

Optionally, the method includes teaching the person to identify grounding faults.

Optionally, the closing of the one or more switches is done out of view of the person. The method may include concealing the plurality of electrical switches immediately after the closing, in particular, closing a door for covering the switches.

The door may be locked to prevent the person from seeing which of the plurality of electrical switches are closed.

### BRIEF DESCRIPTION OF THE DRAWINGS

FIG. 1 is an electrical schematic diagram of a simulator of the invention.

FIG. 1A is a magnified view of a portion of FIG. 1.

FIG. 2 illustrates a control panel of the simulator of FIG. 1.

### DETAILED DESCRIPTION OF THE INVENTION

EVs as referenced herein do not include electric vehicles that use low voltage batteries operating at less than 30V to store the energy to propel the vehicles such as golf carts. Hybrid vehicles as referenced herein refer to vehicles having an internal combustion engine and a high voltage battery, both of which can provide the energy to propel the vehicle.

Simulator and other terms sharing the same simulate root as used herein does not refer to a virtual simulation but refers to a physical object or system that simulates something else. Indeed, the simulator disclosed herein preferably contains components that are used in EVs to make the simulator more realistic.

As used herein, ground fault refers to a short or an electrical fault caused by an unintended ground, typically caused by insulation wearing out.

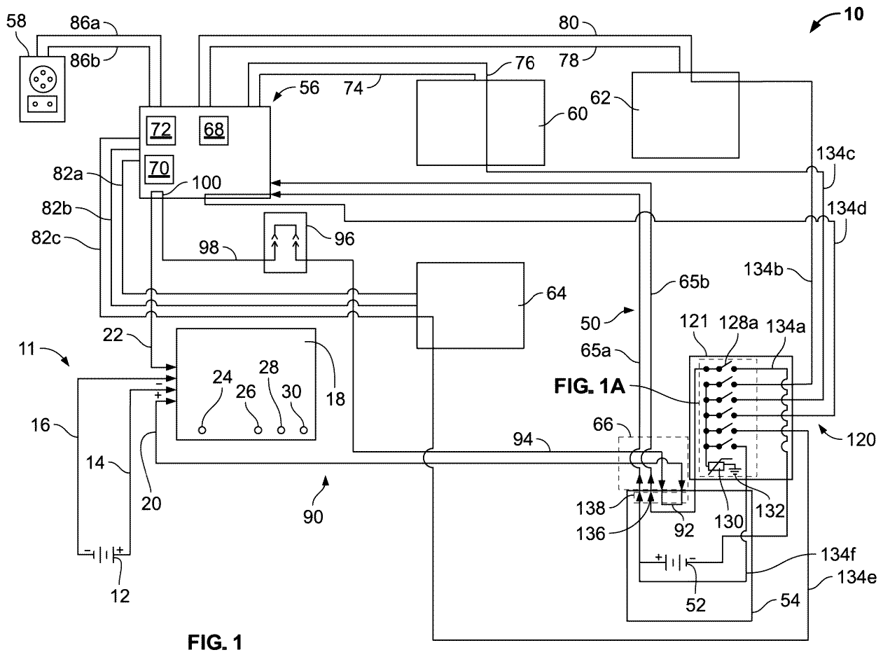

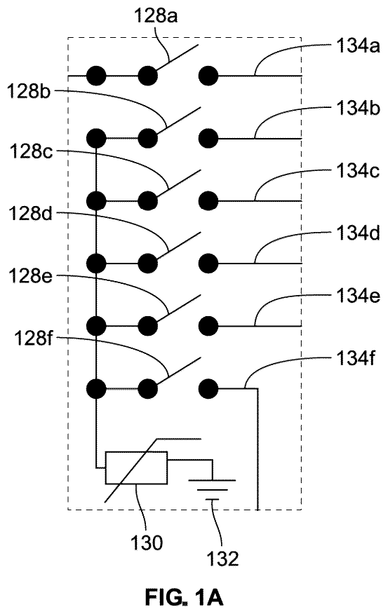

With reference to FIG. 1, a simulator 10 for an EV is disclosed. Simulator 10 has four main subsystems: a low voltage circuit 11, a simulated high voltage circuit 50, an electrical loop 90, and a ground fault simulator 120.

Turning first to low voltage circuit 11, circuit 11 has a low voltage battery 12 having a maximum voltage of 30 V; battery 12 may be nominally a 12 V one, or a 6 V one, or a 24 V one. Battery 12 is connected electrically by lines 14 and 16 (part of circuit 11) to an ignition box 18. Ignition box 18 simulates the “ignition” of a conventional vehicle and certain status lights typically found in the dash or information center of an EV. Ignition box 18 includes a key sensor 24 for activation by a key, typically of a type used for EVs, and a relay. When key sensor 24 is activated by the key, the relay is closed applying voltage to line 20 and line 22 of electrical loop 90. Key sensor 24 may be a reed switch which is activated by a magnet attached to the key, e.g., the magnet may be in a key fob.

Ignition box 18 has a light 26, a light 28 and a light 30, which are preferably green, yellow and red, respectively, but a single multi-color light could be used instead. Light 26 being on signifies that key sensor is activated by the key and electrical loop 90 is closed. Light 28 being on signifies that key sensor 24 is not activated by the key. Light 30 being on signifies that that key sensor 24 is activated by the key, but electrical loop 90 is open. Lights 26, 28 and 30 are indicators of the status of loop 90 and of the status of key sensor 24; other kinds of indicators such as an LED or LCD display may be used instead to provide the statuses. One of skill in the art is capable of designing ignition box 18.

The purpose of simulated high voltage circuit 50 is to simulate the high voltage circuit or circuits of an EV, but without the electrocution risk of death. To that end, circuit 50 has a low voltage battery 52, which preferably is of the 6 V, 12 V one, or a 24 V type, as the main source of electricity rather than a battery having a voltage of 400-900V. Battery 52 may be contained in an enclosure 54.

Circuit 50 has an electric motor electronics unit or EME 56, a charge port 58, an air conditioning (“A/C”) compressor 60, a heater 62, and a stator 64. These components (e.g., components 56-64 or components 58-64 and 68-72) are preferably the same as what may be found in an EV for a more realistic training experience. Battery 52 may be connected by a cable to EME 56; the cable includes lines 65a and 65b. The cable has a plug 66 (shown with a dashed line) plugged into a socket in enclosure 54. EME 56 has a DC/DC converter 68, an inverter 70, and an on board charger 72. DC/DC converter 68 provides power at a lower DC voltage, typically nominally 250 V, to A/C compressor 60 and heater 62, via electrical lines 74, 76, 78 and 80. Heater 62 may be any suitable heater, but a PTC heater is preferred as this is the type of heater most frequently used in EVs. Alternatively, or in addition to A/C compressor 60 and heater 62, circuit 50 may have a heat pump compressor. Inverter 70 is connected electrically to stator 64 by three lines 82a, 82b, and 82c for carrying 3-phase AC. Stator 64 may be accompanied by a corresponding rotor to form an electric motor, but it is preferred that there is no rotor for safety reasons. On board charger 72 is connected to charge port 58 by lines 86a and 86b.

Electrical loop 90 is intended to simulate an EV's or a hybrid's high voltage interlock loop, which when broken or discontinuous causes various relays which supply high voltage electricity to be open in a conventional EV. Loop 90 includes line 20, line 22, line 92, line 94, a low voltage shut down switch 96, line 98 and line 100. Line 20 extends between ignition box 18 and enclosure 54 through plug 66. Line 20 electrically connects to line 92, which is electrically connected to line 94. Unplugging plug 66 disconnects lines 22, 92 and 94. Line 94 is electrically connected to low voltage shut down switch 96. Switch 96 often takes the form of a plug and socket, the unplugging of which disconnects line 94 from line 98. Line 98 and 22 are connected by line 100. They are connected to EME 56 by a plug or plugs (not shown) which operate similar to plug 66 in terms of breaking loop 90.

Loop 90, i.e., line 20 and line 22, passes through ignition box 18. If key sensor 24 of ignition box 18 is activated by the key, a relay is closed applying voltage to line 20 and line 22. If loop 90 is closed, then there will be current in loop 90 and green light 26 will illuminate otherwise red light 30 will illuminate. Loop 90 may include additional simulated interlocks as might be typically found on EV or hybrid in connectors, cut loops or other means to institute additional fault conditions as desired by an instructor.

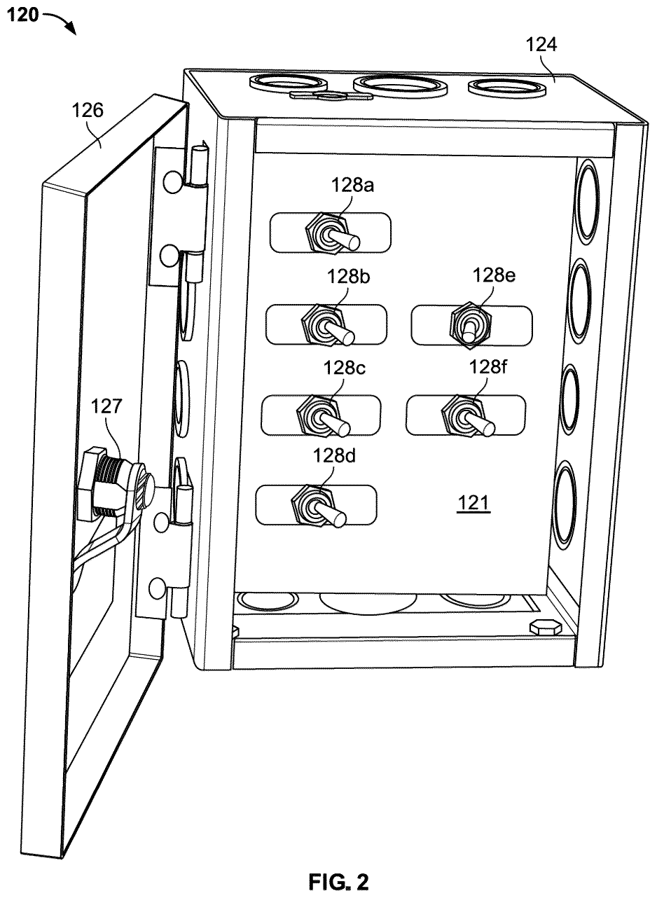

With reference to FIGS. 1, 1A and 2, ground fault simulator 120 includes a panel 121, preferably, contained in an electrical enclosure 124 with a door 126 having a lock 127. Panel 121 includes a plurality of electrical switches 128 for generating different ground faults throughout simulator 10 to simulate a loss of insulation in an electrical component in an EV or hybrid. Switches 128 are electrically connected to a resistor 130, which in turn is connected to a ground 132. Resistor 130 is preferably a varistor, which presents infinite resistance at low voltage and finite resistance at high voltage to emulate the loss of insulation. Preferably ground is a wheeled metal cart to which simulator 10 is attached and which supports simulator 10. Ground 132 is connected to enclosure 124, which is electrically bonded to the cart. On the side opposite to ground 132, switches 128a-128f are connected to the negative terminal of battery 52, heater 62, A/C compressor 60, EME 56, stator 64, and to line 65b by lines 134a-134f, respectively. Switch 128a is useful to simulate a stuck contactor 136 in socket 138 (shown with dashed lines) of battery enclosure 54 into which plug (or connector) 66 plugs. Switch 128f is useful to simulate a ground fault at battery 52.

Line 134 may be connected to the various components by any suitable method for simulating a ground or isolation fault. Preferably, line 134b is connected to either line 78 or 80 within the enclosure for heater 62. Preferably, line 134c connects to either line 74 or 76 within the enclosure for AC compressor 60. Preferably, line 134d connects to a bus bar of EME 56. Preferably, line 134e connects to one of the coiled wires in the core of stator 64.

Turning now to another embodiment of the invention, a method of training a person to service an EV or a hybrid will be discussed with reference to simulator 10. Students are trained by an instructor to break loop 90, typically by shut down switch 96, which in an EV would turn off the high voltage, and to check one or more indicators, e.g., lights 26, 28 and 30, to make sure that it is safe to work on the EV or hybrid. They then learn how to check for isolation faults and test equipotential bonding after completing repairs. Finally, students are trained on the correct procedures for safely powering the HV system back up.

The method includes simulating one or more grounding faults in simulator 10 by closing one or more of switches 128a-128f. Preferably, the closing is done out of view of the person being trained and switches 128a-128f are concealed by closing door 126 and locking lock 127. Next the person is allowed to identify which component of the simulator has been grounded. Usually, the person is taught how to identify grounding or isolation faults on simulator 10. One way to identify an isolation fault is to use a megaohm meter and service documentation. A person can compare measured isolation values to the specified thresholds in the service documentation. If isolation falls below specifications, they diagnose the issue by disconnecting one high-voltage (HV) component at a time and retesting the system. If the isolation value returns to normal after disconnecting a component, the last disconnected component is likely the source of the fault. This process of elimination continues until the faulty component is identified. Once isolated, the suspect component is tested further to confirm the loss of isolation. Another way of identifying isolation faults is to use an isolation tester to apply high voltage at low current to a circuit to identify if there is leakage (current flow) through unintended paths.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A low-voltage simulator for physically simulating electrical faults in an electric vehicle or a hybrid vehicle having a high voltage electrical motor for training automotive technicians to physically locate electrical faults in the electric vehicle, the simulator comprising:
an electric motor electronics unit having an inverter, a DC/DC converter and an on board charger,
a first battery for simulating a high voltage battery, the first battery connected to the electric motor electronics unit,
a plurality of electrical switches for simulating ground faults within the simulator, each of the plurality of electrical switches being connected to a ground and to a different electrical component of the simulator, the electrical components comprising the electric motor electronics unit and the first battery.

2. The simulator of claim 1, further comprising a stator of an electric motor connected to the electric motor electronics unit, the stator being an electrical component of the simulator, the plurality of electrical switches including a switch for simulating a ground fault at the stator.

3. The simulator of claim 2, further comprising at least one environmental control unit selected from air conditioning compressor, a heater, and combinations thereof, the at least one environmental control unit connected to the electric motor electronics unit and being an electrical component of the simulator, the plurality of electrical switches including at least one switch for simulating a ground fault at the least one environmental control unit.

4. The simulator of claim 1, further comprising an opaque enclosure around the plurality of electrical switches.

5. The simulator of claim 1, wherein the enclosure comprises an opaque locking door for providing access to the switches and hiding the switches when the door is closed.

6. The simulator of claim 1, further comprising a varistor, wherein the plurality of electrical switches are grounded through the varistor.

7. The simulator of claim 1, further comprising a metallic wheeled cart for supporting the simulator, the plurality of electrical switches being grounded to the wheeled cart.

8. The simulator of claim 1, further comprising an electrical loop for simulating a high voltage interlock loop in the electric vehicle or the hybrid vehicle, a key sensor for simulating an ignition switch of the electric vehicle or the hybrid vehicle, and one or more indicators for indicating a status of the key switch and a status of the electrical loop.

9. A method of training a person to repair an electric vehicle or a hybrid vehicle having a high voltage battery for storing energy to propel the vehicle using a low-voltage simulator for physically simulating electrical faults in the vehicle, the simulator comprising (a) an electric motor electronics unit having an inverter, a DC/DC converter and an on board charger, (b) a first battery for simulating a high voltage battery, the first battery connected to the electric motor electronics unit, and (c) a plurality of electrical switches for simulating ground faults within the simulator, each of the plurality of electrical switches being connected to a ground and to a different electrical component of the simulator, the electrical components comprising the electric motor electronics unit and the first battery, the method comprising:
simulating one or more grounding faults in the simulator by closing one or more of the switches.

10. The method of claim 9, further comprising allowing the person to identify which component of the simulator has been grounded.

11. The method of claim 10, wherein the simulator further comprises an electrical loop for simulating a high voltage interlock loop in the electric vehicle or the hybrid vehicle, a key sensor for simulating an ignition switch of the electric vehicle or the hybrid vehicle, and one or more indicators for indicating a status of the key switch and a status of the electrical loop, the method further comprising instructing the person to break the loop and to check the one or more indicators before allowing the person to identify which component of the simulator has been grounded.

12. The method of claim 9, further comprising teaching the person to identify grounding faults.

13. The method of claim 9, wherein the closing the one or more switches is done out of view of the person.

14. The method of claim 9, further comprising concealing the plurality of electrical switches after the closing.

15. The method of claim 14, wherein concealing the plurality of electrical switches comprises closing a door for covering the switches.

16. The method of claim 15, further comprising locking the closed door to prevent the person from seeing which of the plurality of electrical switches are closed.
